(19) United States
(12) Patent Application Publication
(10) Pub. No.: US 2009/0132291 A1
(43) Pub. Date: May 21, 2009

(54) Method and system for management of selling and buying items

(76) Inventor: Jay Schmitt, Huntington, NY (US)

Correspondence Address: Feldman Law Group, PC, 12 East 41st Street, New York, NY, 10017, US

(21) Appl. No.: 11/986,422

(22) Filed: Nov. 21, 2007

(51) Int. Cl. G06Q 20/00; G06Q 40/00; G06Q 30/00

(52) U.S. Cl. 705/4; 705/26

(57) ABSTRACT

An online system and method where a user can post items for selling and where the payment the user receives is depositable in a plurality of saving options that include insurance policies, financial accounts, investment plans, accounts with investment groups and banks. The invention comprises steps of: (1) allowing users to decide designating a saving option account; (2) allowing users to decide composition of saving options; (3) allowing users to decide depositing priority of saving options.(4) allowing users to post items for sale such that the items are searchable by other users searching a database; and (5) allowing buyers to deposit payment in said designated saving option account.

### BACKGROUND OF THE INVENTION

1. Field of the Invention

The invention relates to Internet services, and more particularly to a website permitting users to sell and purchase products.

2. Description of the Related Art

Websites that provide online services and software for cataloging, auctioning, selling, buying goods and products are aplenty in the prior art. In these websites when good and products are sold the money is deposited in a seller's account. This money is can be readily spent and saving for future needs such as a child's college education, health insurance, investment in real estates and mutual funds, for example is not encouraged. Moreover, users who get money after selling goods do not have control over their own saving options and priority.

There is a need needed is a method and system for selling and buying goods and products where sellers can get the money deposited in accounts that encourage savings. There is also need for method and system for selling and buying goods and products where users can select their own saving options and priorities.

### SUMMARY OF THE INVENTION

An online system and method where a user can post items for selling and where the payment the user receives is depositable in a plurality of saving options that include insurance policies, financial accounts, investment plans, accounts with investment groups and banks. The invention comprises steps of: (1) allowing users to decide designating a saving option account; (2) allowing users to decide composition of saving options; (3) allowing users to decide depositing priority of saving options.(4) allowing users to post items for sale such that the items are searchable by other users searching a database; and (5) allowing buyers to deposit payment in said designated saving option account.

### BRIEF DESCRIPTION OF THE DRAWINGS

The above mentioned and other features, aspects and advantages of the present invention will become better understood with regard to following description, appended claims and accompanying drawings, wherein like reference numerals refer to similar parts throughout the several views where:

FIG. 1 is a diagrammatic view of the a system in accordance with the present invention;

FIG. 2 is a flow chart for a method for opening an account, according to the present invention, implemented by the system in FIG. 1;

FIG. 3 is a flow chart of a method a buyer employs when searching and purchasing items, according to the present invention, implemented by the system in FIG. 1;

FIG. 4 is a flow chart of a method a buyer employs when editing account settings and managing items posted for sale, according to the present invention, implemented by the system in FIG. 1;

FIG. 5 shows display screen that welcomes a visitor when browsing;

FIG. 6 shows a display screen a user sees when a user edits the user details;

FIG. 7 shows a display screen a user sees when selecting a saving options;

FIG. 8 shows a display screen a user sees when selecting a financial institution, an insurance company, an investment group, a bank or the like for depositing a payment of money;

FIG. 9 shows a display screen a user sees when giving details of a designated account with the selected financial entity;

FIG. 10 shows a display screen a user sees when selecting a savings mix and a savings priority for the money that will be deposited;

FIGS. 11-13 show display screens as seen by a buyer when searching items for buying;

FIGS. 14-15 show display screens as seen by a buyer when making a payment to seller reference numbers; and

FIGS. 16-19 show display screens as seen by a seller when editing account settings and managing items posted for sale;

### DETAILED DESCRIPTION OF THE DRAWINGS

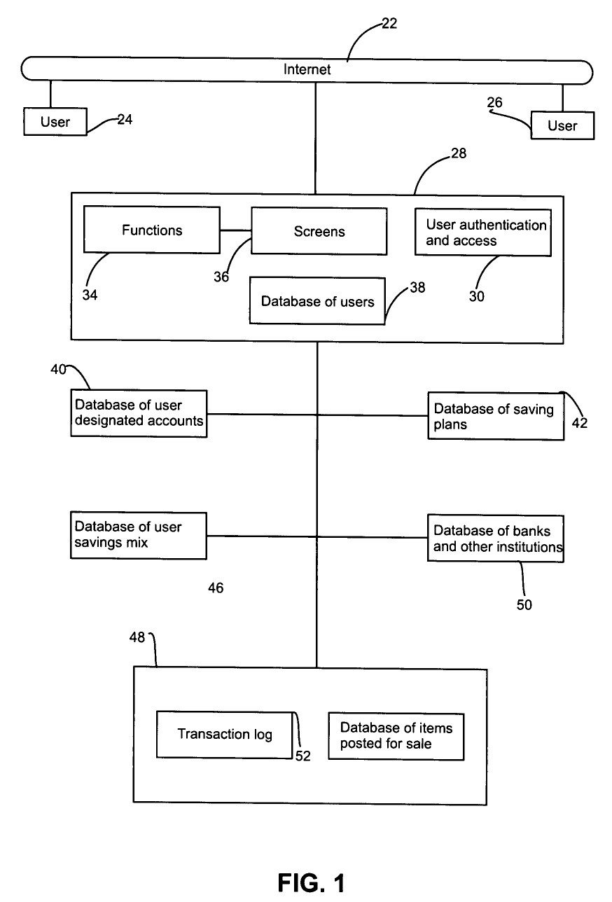

FIG. 1 shows a block diagram of an online system for management of selling items in lieu of savings options accordance with the present invention. A first server 28 is linked to the Internet 22 to service a number of users 24, 26. The first server 28 provides user authentication and access 30 to a number of other servers in a network 32. The first server 28 includes functions 34, screens 36, and a database of users 38. Functions 34 include various programs that facilitate user activities such as search, login, logout, making payment, adding and deleting details, for example. Files relating to user designated accounts, user saving plans, user saving mix, items posted by user for sale and files relating to associated banks and financial institutions are spread over servers 40, 42, 46, 48, 50 respectively. Server 48 also includes a transaction log 52 of items sold, bought and recalled.

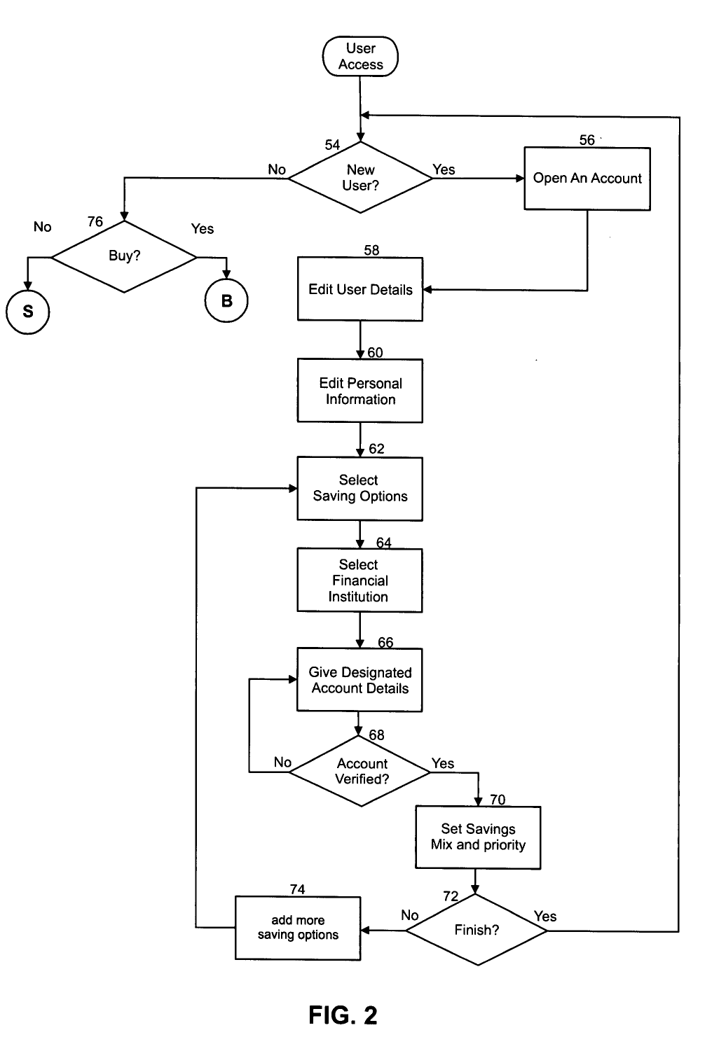

FIG. 2 shows a flowchart of a typical sequence of a user access when opening an account of the system implement in FIG. 1. The actual sequence of user access may vary from that shown in FIG. 2, because user may access various links, tabs and buttons that are available as desired and as needed.

In step 54 of FIG. 2, execution branches to step 56 if the user is new to the system. In steps 56, 58 and 60, the system registers the user, sets a default profile for the use and registers the user by receiving some information about the user, assigning a unique user id selected by the user, obtaining a password from the user, and creating a file for storing the user information and user profile. After steps 56, 58 and 60, execution continues to step 62.

In step 62, the user selects a saving option. Each saving option represents a class of financial entity associated with the system. Saving option is selected one at a time from a list of available classes. After step 62, execution continues to step 64.

In step 64, the user selects a financial entity enlisted in the class of financial entities or saving option selected in step 62. For example, the saving option can be banking and the user can select from a plurality of banking entities associated with the system. After step 64, execution continues to step 66.

In step 66, the user designates a pre-existing account with the financial entity selected in step 64 to the account being set up. The account can belong to the user or the user can nominate another person. For example, the user can nominate spouse, parents and children. The account is necessary for receiving payments from buyers that purchase user posted items for sale. After step 66, execution continues to step 68.

In step 68, the information about the designated account is sent for verification to the server of the selected financial entity. If the information is verified, the execution continues to step 70, else the execution goes back to step 64. The user is logged out of the system after a specified number of attempts at verifying the designated account information fail.

In step 70, the user sets savings mix and savings priority. The use can decide the share of each saving option or each class of financial entity out of total savings deposited in a user account. For example, a user can set the banking saving option to receive 50% and the insurance saving option to receive 50% of the total payments made by buyers. The use can also prioritize saving options that are selected to receive the payment. For example, the user can give the first priority banking saving option to receive payments, and so on and so forth. After step 70, the execution continues to step 72.

In step 72, the execution branches to step 54 if the user wants to finish setting up his account, else the execution branches to step 62 so that the user can add more saving options.

In step 54 of FIG. 2, execution branches to step 56 if the user is new to the system. The execution branches to step 76 if the user is already registered and not new to the system.

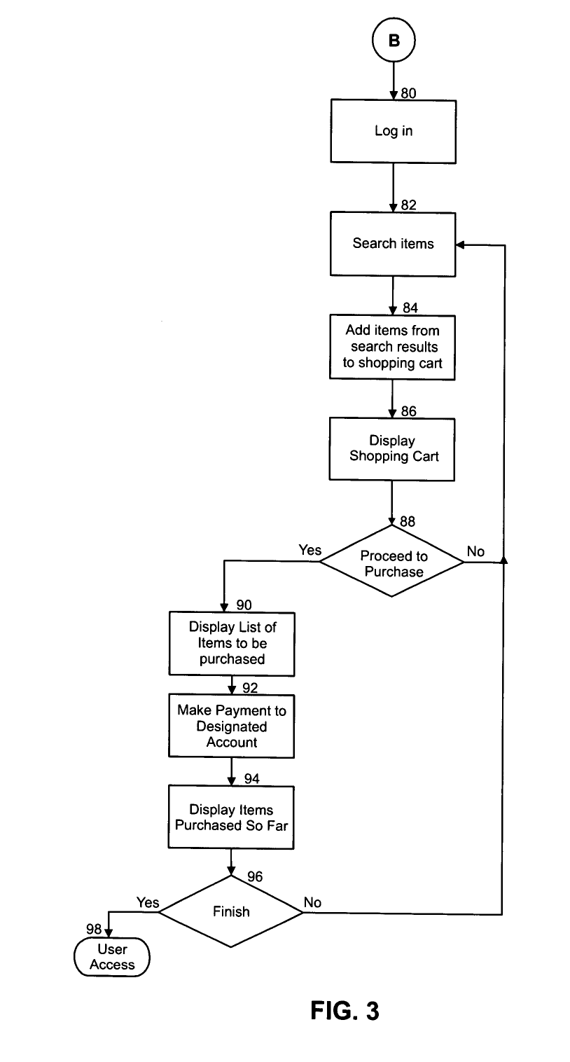

Execution branches to step 78 of FIG. 3, if the user wants to buy items posted for sale. In next step 80, the user enters username and password to log in. The successful execution of step 80 leads to step 82. In step 82, the user searches the system for items posted for sale using keyword search. The user can also use categories and subcategories to refine the search. After step 82, the execution continues to step 84.

In step 84, the user selects items from search results and adds them to shopping cart. After step 84, the execution continues to step 86. In step 86, the items that are added to the shopping cart are displayed. After step 86, the execution continues to step 88. In step 88, the execution branches to step 82 if the user does not want to continue with purchasing the items in the shopping cart.

The execution branches to step 90 if the user wants to proceed with purchasing of items in the shopping cart. In step 90, the user selects items to be purchased from the items in the shopping cart and the execution continues to step 92. In step 92, the user makes payment to designated accounts of sellers and execution continues to step 94 that displays items purchased so far by the user. After step 94, the step continues to step 96. In step 96, the execution branches to step 98 that takes user to system user access. The execution branches to step if the user wants to continue searching for items posted for sale.

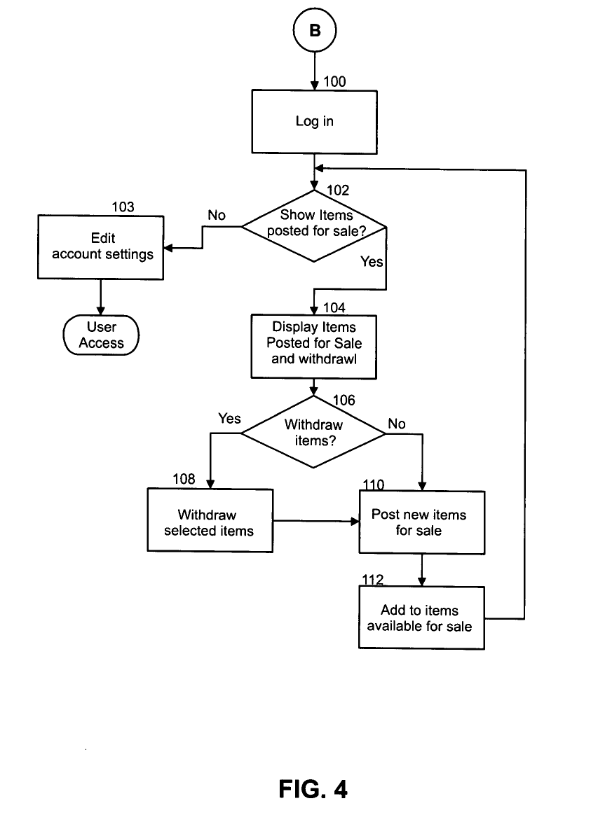

Execution branches to step 100 shown in FIG. 4, if the user wants to post items for sale. In step 100, the user logs in entering his username and password and the execution continues to step 102. In step 102, the execution branches to step 103 if the user does not want to be shown a display items posted for sale. In step 103, the user edits his account settings and the execution continues to user access.

In step 102, the execution branches to step 104 if the user wants to be shown a display of items posted for sale by the user. In step 104, the user gets a display of items of posted. In step 104, the items that the user wants to withdraw can also be selected. After the step 104, the execution continues to step 106.

In step 106, the execution branches to 108 if the user wants to withdraw items selected in step 104. In step 108, the items selected are deleted from items posted for sale and execution continues to step 110.

In step 106, the execution branches to 110, if the user does not want to withdraw posted items. In step 110, the user posts new items for sale and the execution continues to step 112. In step 112, new items posted are added to items posted for sale and the execution continues to step 102.

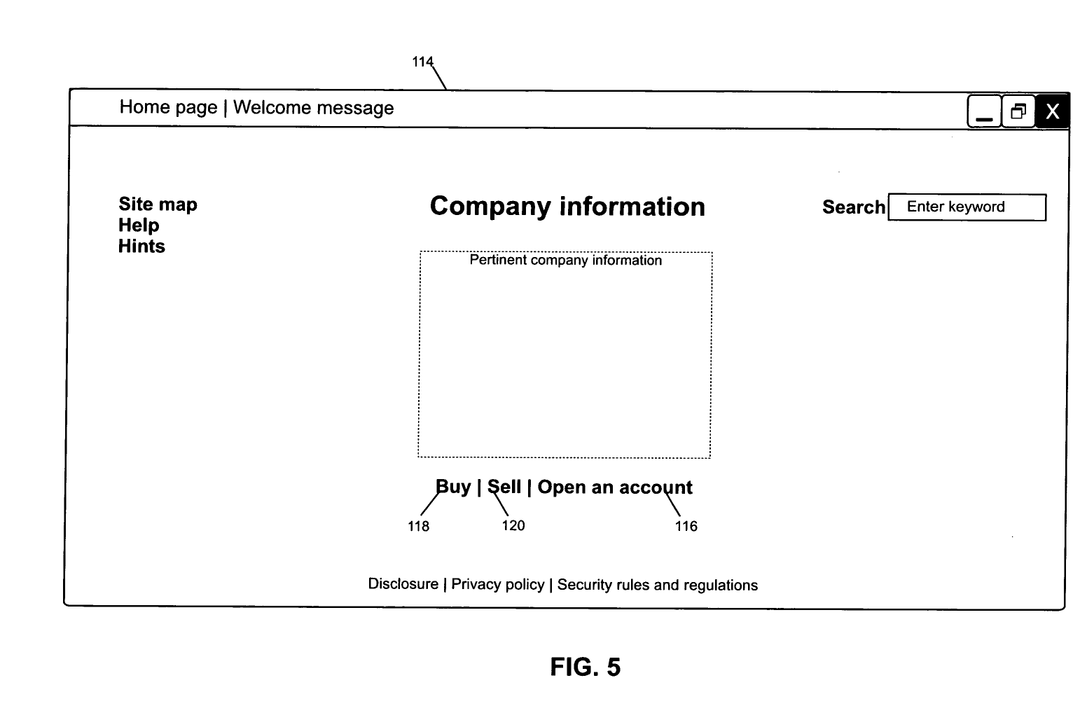

Referring now to FIGS. 5-10, the steps involved in opening and setting up a user account are explained. FIG. 5 illustrates a display screen 114 entitled “Home page|Welcome message” where a user may open account by clicking a button 116 designated as “Open an account.” The user may proceed to buy by clicking a button 118 designated as “Buy” and the user may proceed to sell by clicking a button 120 designated as “Sell.”

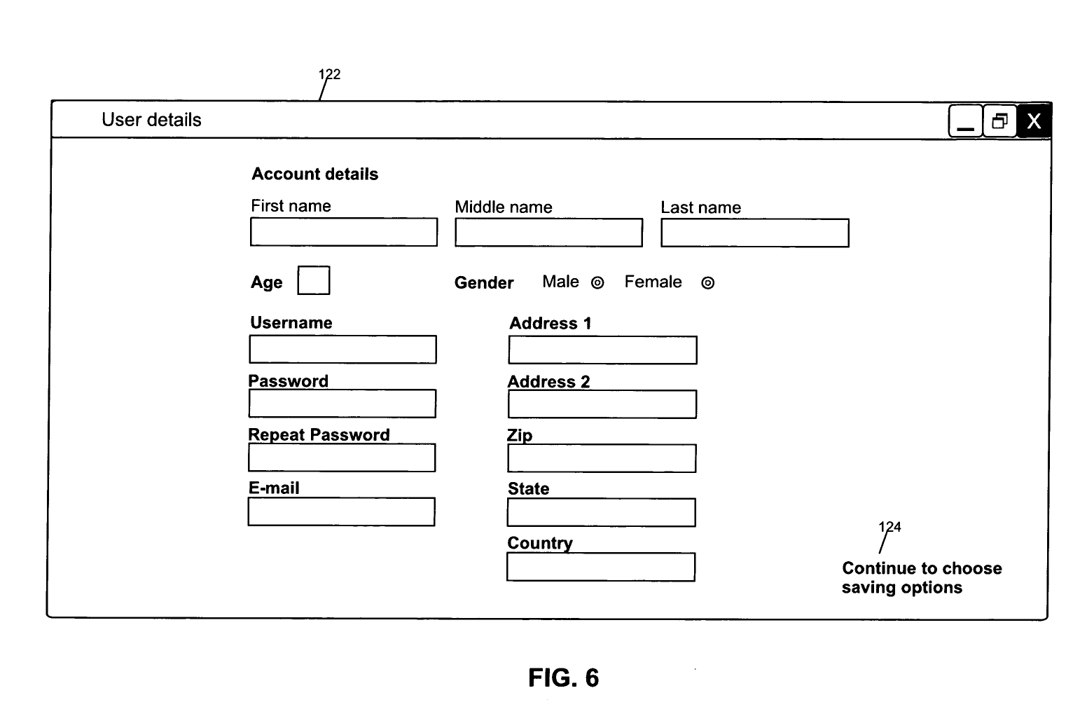

FIG. 6 illustrates a display screen 122 entitled “User details” that is generated upon clicking “Open an account” button 116 where the user may submit account details, username and password, and so on so forth. The user may proceed to choosing saving options by clicking a button 124 designated as “Continue to choose saving options.”

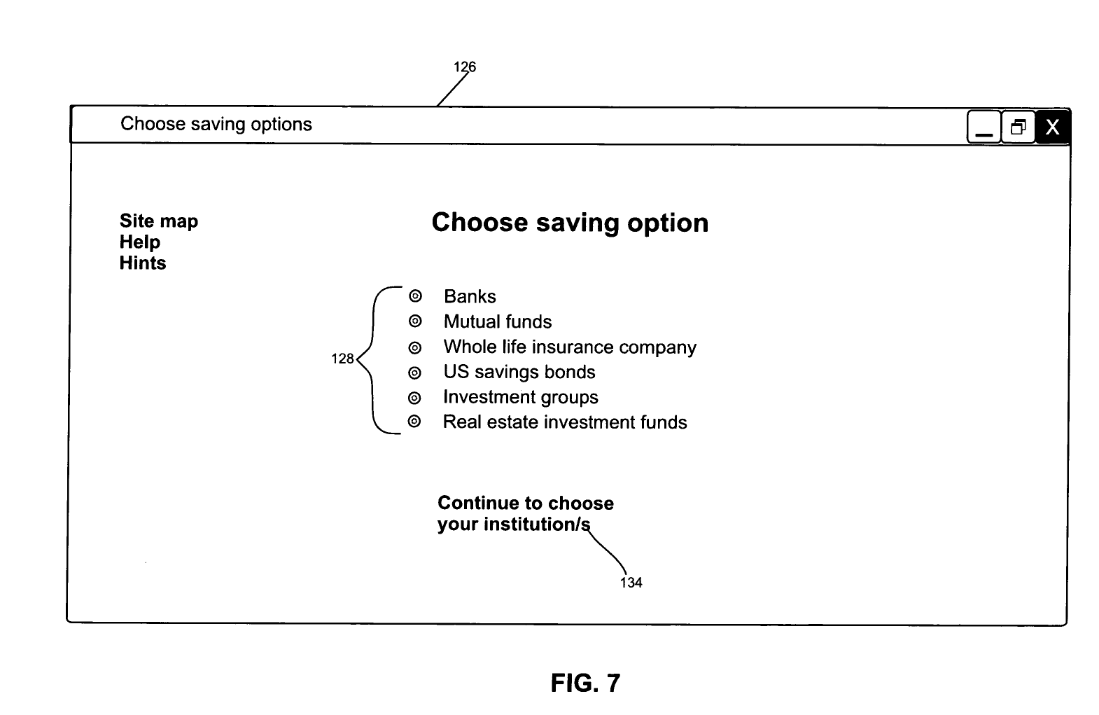

FIG. 7 illustrates a display screen 126 entitled “Choose saving options” that is generated upon clicking button 124 where a user may choose a savings option from a list of radio buttons. The enlisted savings options include options 128 such as, but not limited to, banks, mutual funds, whole life insurance, US savings bonds, investment groups, real estate investment funds, for example. The user may proceed to choosing a financial institution belonging to the savings option category selected by clicking a button 134 designated as “Continue to choose your institutions.”

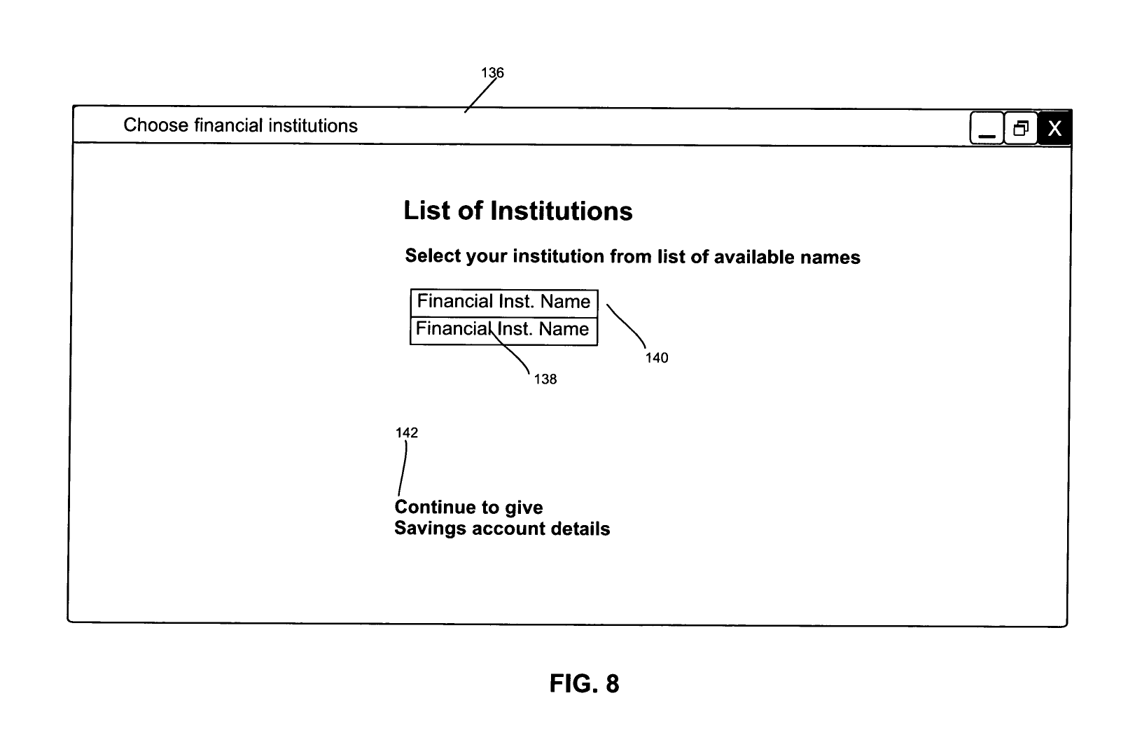

FIG. 8 illustrates a display screen 136 entitled “Choose financial institutions” that is generated upon clicking button 134 where the user may choose financial institution 138 belonging to the saving option selected earlier from a drop down list 140 labeled “Select your institutions from list of available names.” The user may proceed to give further details by clicking a button 142 designated as “Continue to give savings account details.”

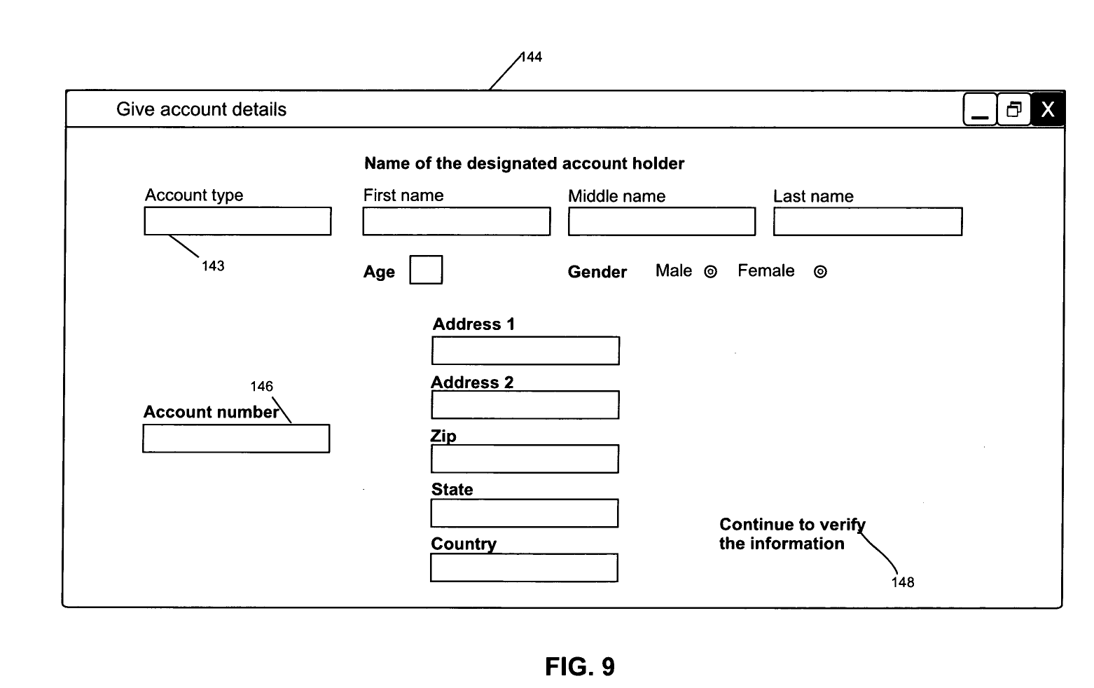

FIG. 9 illustrates a display screen 144 entitled “Give your account details” that is generated upon clicking button 142 where user may give details about the account a pre-existing account belonging to financial institution 138 belong the saving option selected. This is the account where the payment made by a seller will be deposited. The user submits details such as, account type 143, account number 146 and other important details. The user may proceed to get all the information verified by clicking a button 148 designated as “Continue to verify the information.”

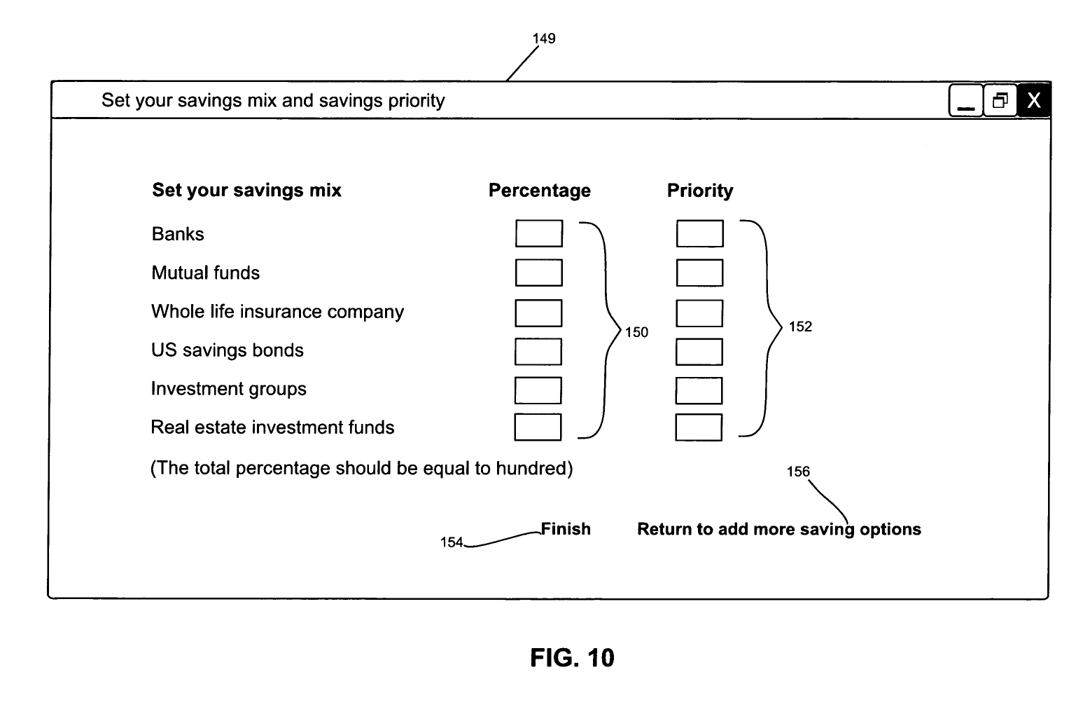

FIG. 10 illustrates a display screen 149 entitled “Set your savings mix and savings priority” that is generated upon clicking button 148 where user may set his savings mix 150 and savings priority 152. Savings mix 154 is defined the total composite of saving options selected by user. The user can customize the savings mix 150 by setting the percentage share of each chosen savings option. The user can also set savings priority 152 by giving the priority number to each savings option. The savings option with highest priority number will have the highest priority when a payment is made to the account of user and so on and so forth. The user may proceed to return to home page by clicking a button 154 designated as “Finish” or may proceed to add more savings options by clicking a button 156 designated as “Return to add more saving options.”

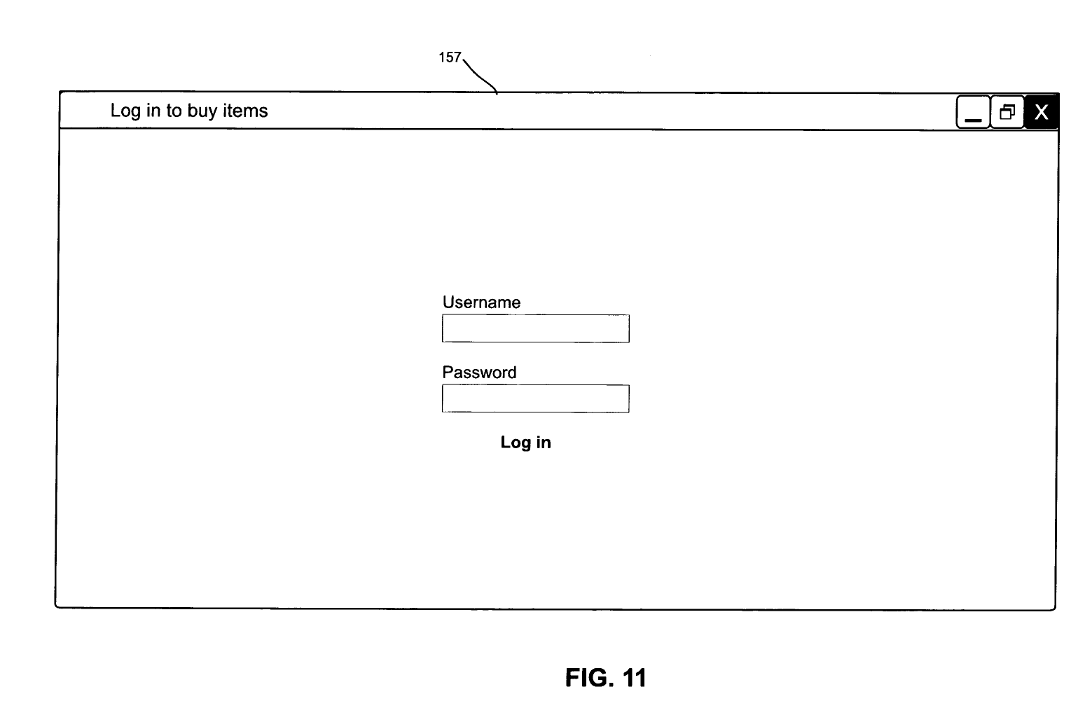

Referring now to FIGS. 11-15, the steps involved in buying an item posted for sale is explained. FIG. 11 illustrates a display screen entitled “Log in to buy items” where the user enters his username and password. The user proceeds to search items for on successfully logging.

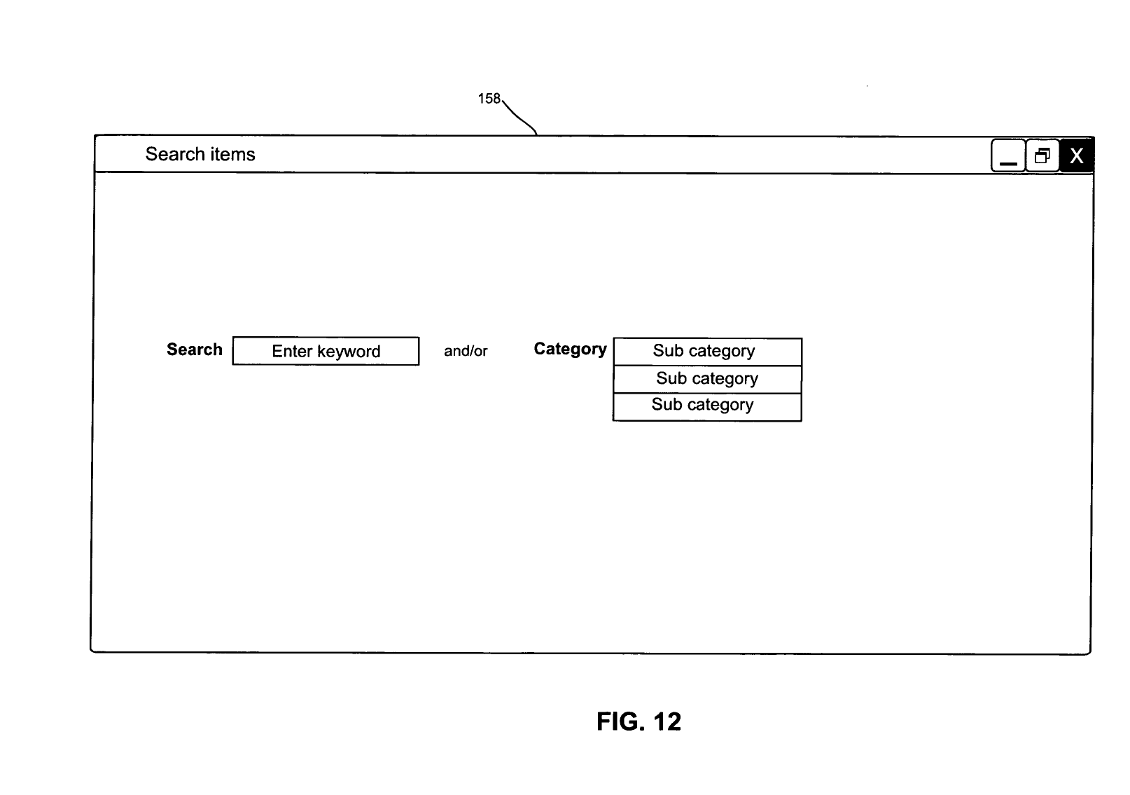

FIG. 12 illustrates a display screen 158 entitled “Search items” that is presented to a buyer on successful log in where user may search items for sale by entering a keyword in input text labeled “Search”. In addition, the user can refine the search by selecting a category and/or a subcategory from a drop down list labeled “Category.”

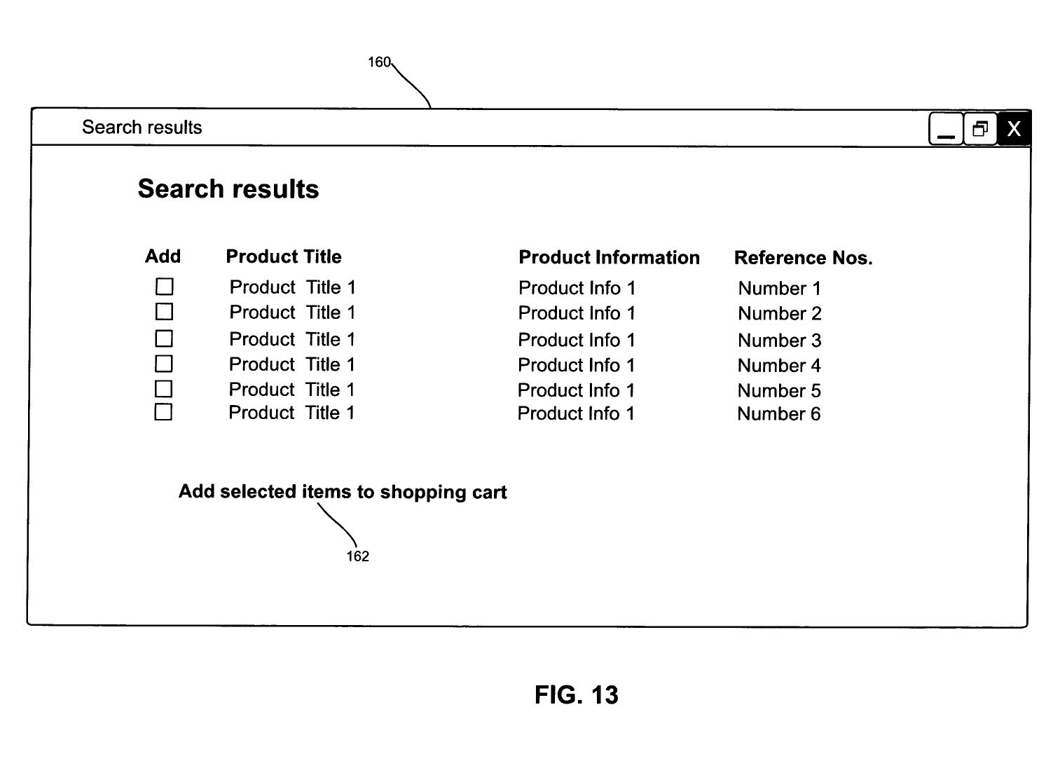

Referring to FIG. 13, a display screen 160 entitled “Search results” that generated on submission of search keyword and/or search category is illustrated where user can add items from search results to shopping cart. The user proceeds to adding items to shopping cart by clicking a button 162 designated as “Add selected items to shopping cart.”

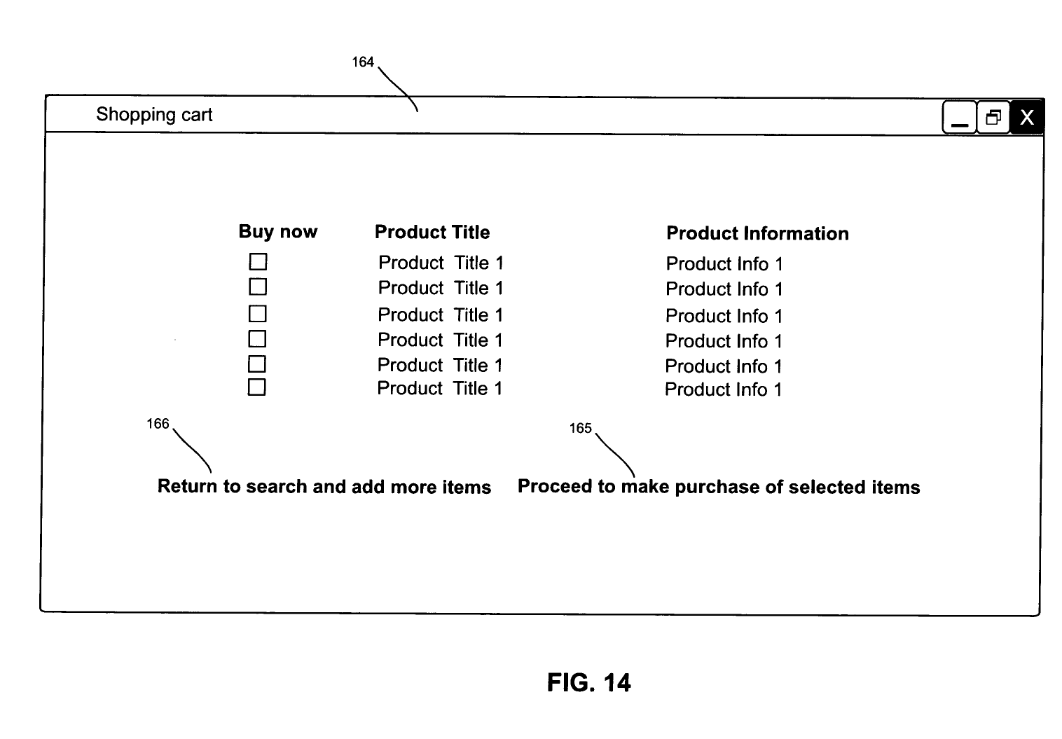

Referring to FIG. 14, a display screen 164 entitled “Shopping cart” generated upon clicking button 162 is illustrated where user may select items. The user proceeds to buying by clicking a button 165 designated as “Proceed to make purchase of selected items” or returns to searching adding more items to cart by clicking a button 166 designated as “Return to search and add more items.” to search and add more items.

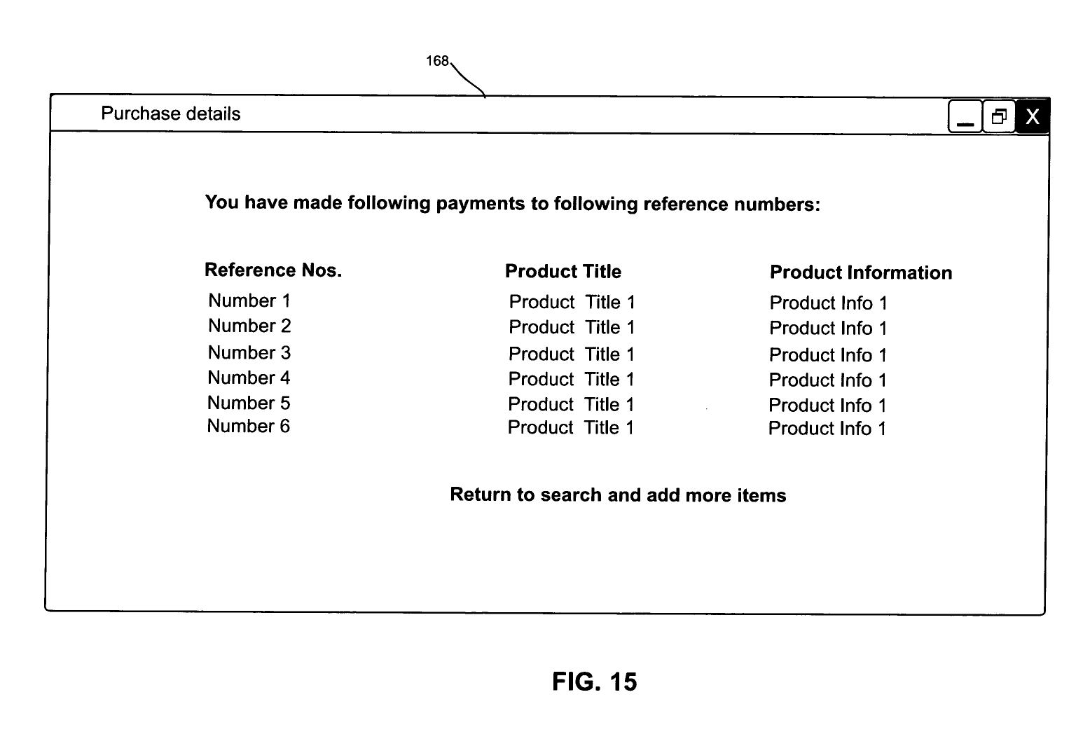

Referring to FIG. 15, a display screen 168 entitled “Purchase details” is generated upon clicking button 165. The purchasing process ends here. Here the user may return to searching and adding by clicking by clicking a button designated as “Return to search and add more details”

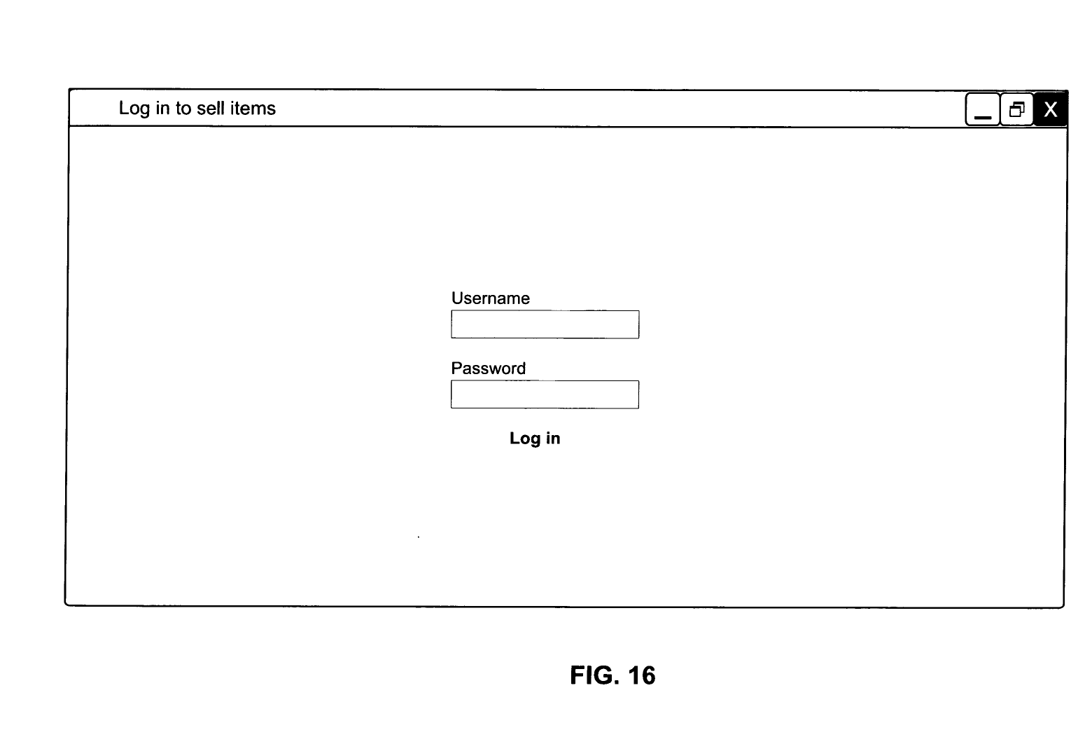

Referring now to FIGS. 16-19, the steps involved when a user posts new items for sale are explained. Referring to FIG. 16, a display screen 168 entitled “Log in to sell items” is illustrated where a user logs in to proceed to posting items for sale.

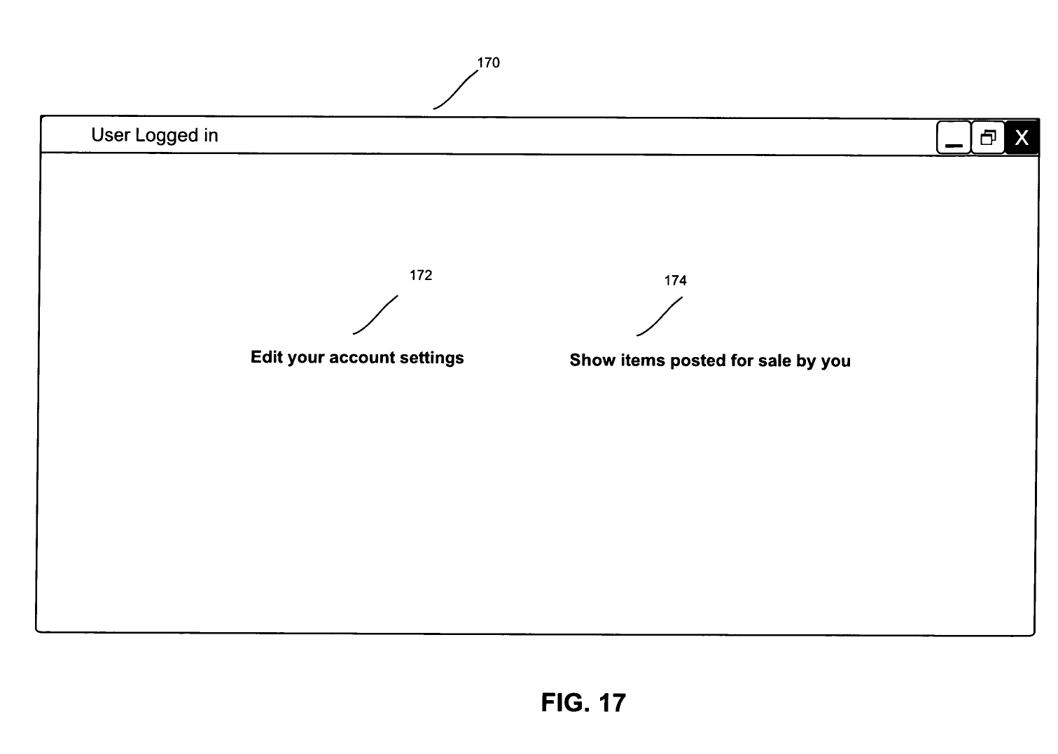

FIG. 17, illustrates a display screen 170 entitled “User logged in” that is generated when the user logs in where user may proceed to edit account settings by clicking on a button 172 designated as “Edit your account settings” or may proceed to get a display of items posted for sale by clicking a button 174 designated as “Show items posted for sale”

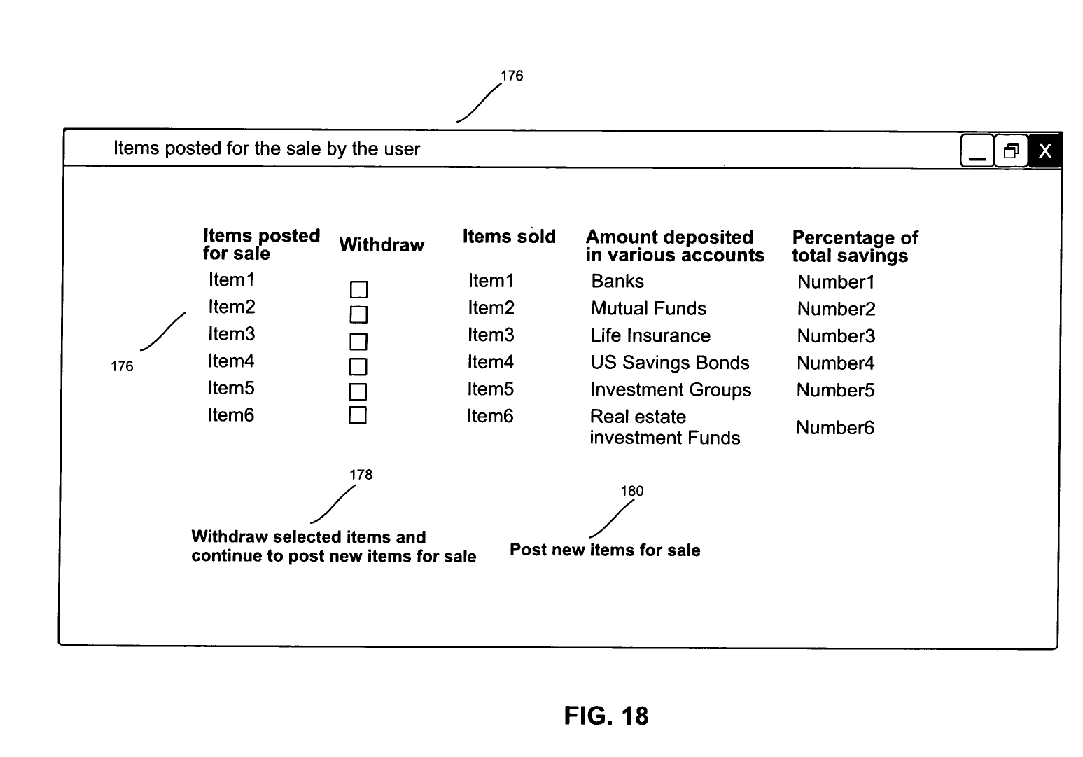

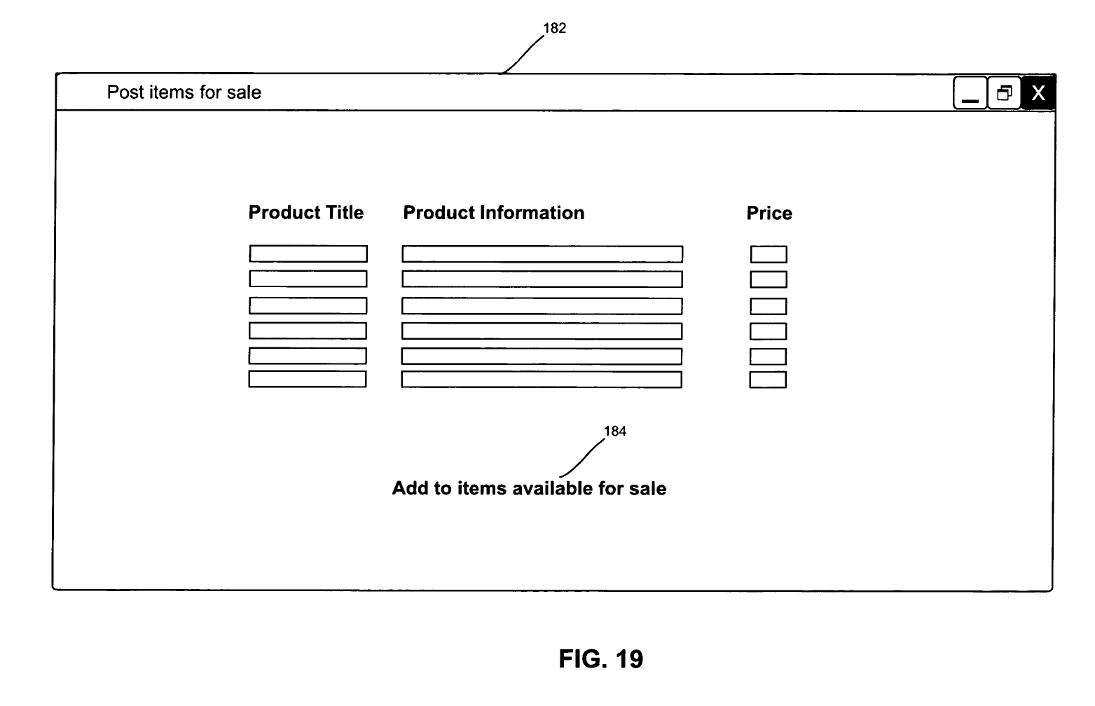

FIG. 18, illustrates a display screen 176 entitled “Items posted for the sale by the user” is generated upon clicking a button 174 where list of items posted for sale by user is displayed. Other lists such as items sold, amount deposited in various designated accounts are also displayed. The user may proceed to withdrawing and deleting the items by selecting choice boxes pertaining to the items to withdrawn. After selecting the items to be withdrawn user may continue posting new items by clicking a button designated as “Withdraw selected items and continue to post new items for sale.” The user may also proceed to posting new items without withdrawing any items by clicking a button designated as “Post new items for sale.” Either of these two options takes the user display screen 182 entitled “Post items for sale” illustrated in FIG. 19 where user can post new items by entering information such as, but not limited to, product title, product information and product price. The user may proceed to return adding more items by clicking a button designated as “Add items available for sale.”

What is claimed is:

1. A system and method for selling and buying goods wherein the payment made to a seller is advantageously depositable in a plurality of saving options, comprising steps of:
(1-1) registering users with at least one designated savings option account for receiving payment;
(1-2) allowing users to decide the composition of saving options;
(1-3) allowing uses to decide the depositing priority of saving options;
(1-4) allowing users to post items for sale such that the items are searchable by other users searching a database; and
(1-5) allowing buyers to deposit payment in said designated saving option account.

2. A system and method of claim 1, wherein said saving options include financial accounts with financial institutions.

3. A system and method of claim 1, wherein said saving options include insurance products of insurance providers.

4. A system and method of claim 1, wherein said saving options include mutual fund products.

5. A system and method of claim 1, wherein said saving options include saving accounts with banks.

6. A system and method of claim 1, wherein said saving options include US savings bonds.

7. A system and method of claim 1, wherein said savings options include real estate investment plans.

8. A system and method of claim 1, wherein said savings options include account with financial investment groups.

9. A system and method for making donations wherein the donation made by donee is advantageously depositable in a plurality of saving options, comprising steps of:
(1-1) registering users with at least one designated saving option account for receiving donations;
(1-2) allowing users to decide the composition of saving options;
(1-3) allowing uses to decide the depositing priority of saving options;
(1-4) allowing donors to deposit payment in said designated saving option account.
